(19) United States
(12) Patent Application Publication
(10) Pub. No.: US 2005/0157190 A1
(43) Pub. Date: Jul. 21, 2005

(54) Combining multiple spectral bands to generate an image

(75) Inventors: Timothy E. Ostromek, Richardson, TX (US); Antonio V. Bacarella, Dallas, TX (US); Rodney L. Doster, Garland, TX (US)

Correspondence Address: DALLAS OFFICE OF FULBRIGHT & JAWORSKI L.L.P., 2200 ROSS AVENUE, SUITE 2800, DALLAS, TX, 75201-2784, US

(73) Assignee: Litton Systems, Inc.

(21) Appl. No.: 10/759,959

(22) Filed: Jan. 16, 2004

(51) Int. Cl. H04N 5/335

(52) U.S. Cl. 348/272

(57) ABSTRACT

Generating an image includes receiving light associated with spectral bands. The following are repeated for each spectral band: an electrical signal is received at an electro-optical element, an optical property of the electro-optical element is changed in response to the electrical signal to filter for a spectral band, and the spectral band is transmitted to a sensor. The spectral bands are sensed at the sensor. The spectral bands are combined to generate a composite signal, and an image is generated from the composite signal.

### TECHNICAL FIELD OF THE INVENTION

This invention relates generally to the field of electro-optical systems and more specifically to combining multiple spectral bands to generate an image.

### BACKGROUND OF THE INVENTION

Electro-optical systems generate an image from image information carried by light. Known electro-optical systems, however, typically cannot efficiently and effectively process image information for a broad spectral range. Consequently, known electro-optical systems for generating an image may be unsatisfactory in certain situations.

### SUMMARY OF THE INVENTION

In accordance with the present invention, disadvantages and problems associated with previous techniques for generating an image may be reduced or eliminated.

According to one embodiment of the present invention, generating an image includes receiving light associated with spectral bands. The following are repeated for each spectral band: an electrical signal is received at an electro-optical element, an optical property of the electro-optical element is changed in response to the electrical signal to filter for a spectral band, and the spectral band is transmitted to a sensor. The spectral bands are sensed at the sensor. The spectral bands are combined to generate a composite signal, and an image is generated from the composite signal.

Certain embodiments of the invention may provide one or more technical advantages. A technical advantage of one embodiment may be that spectral bands are multiplexed together in order to generate an image. By multiplexing spectral bands together, an image having a broad spectral range may be effectively and efficiently generated.

Certain embodiments of the invention may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present invention and its features and advantages, reference is now made to the following description, taken in conjunction with the accompanying drawings, in which:

FIG. 1 is a block diagram illustrating one embodiment of a system for multiplexing spectral bands to generate an image;

FIGS. 2A through 2C illustrate examples of the electro-optical element of FIG. 1;

FIG. 3 is a diagram illustrating an example shift applied to the spectral bands by the electro-optical element of FIG. 1; and

FIG. 4 is a flowchart illustrating one embodiment of a method for multiplexing spectral bands to generate an image.

### DETAILED DESCRIPTION OF THE DRAWINGS

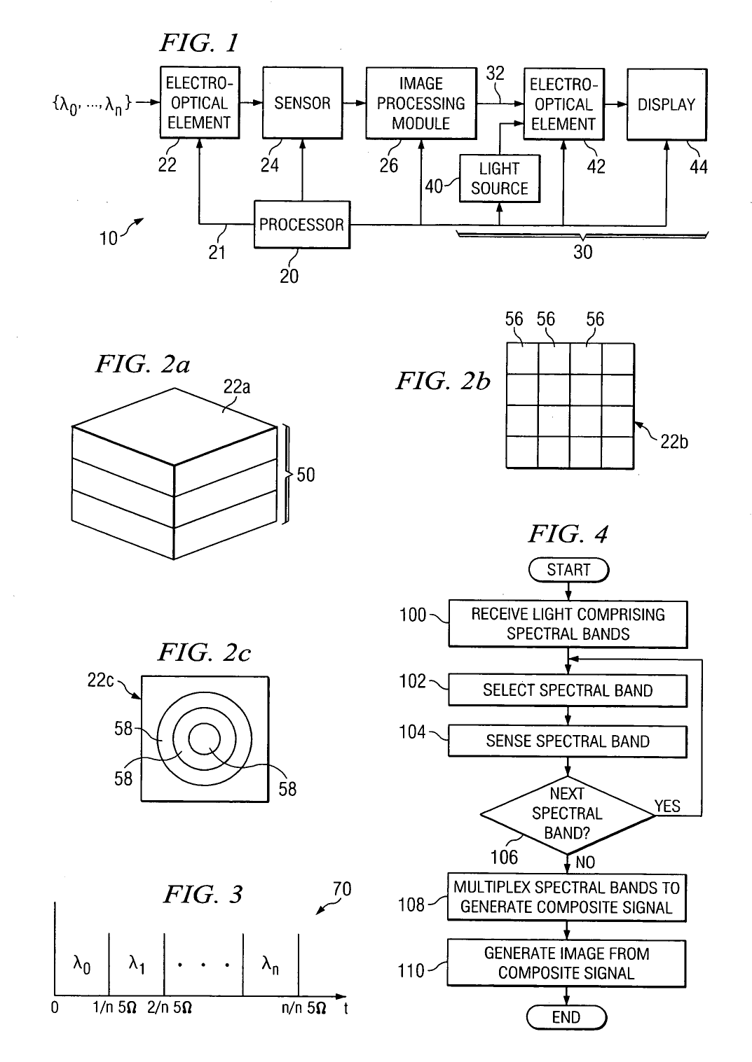

Embodiments of the present invention and its advantages are best understood by referring to FIGS. 1 through 4 of the drawings, like numerals being used for like and corresponding parts of the various drawings.

FIG. 1 is a block diagram of a system 10 for multiplexing spectral bands to generate an image. System 10 filters received light for selected spectral bands. The spectral bands are processed and multiplexed together to generate an image. By multiplexing the spectral bands together, system 10 may provide for generation of an image having a broad spectral range.

According to the illustrated embodiment, system 10 receives light reflected from an object. The light carries image information that may be used to generate an image of the object. The light has wavelengths that may be separated into any number n of spectral bands {λ₀,λ₁, . . . ,λₙ}. Each spectral band comprises a band of wavelengths having any suitable range, for example, 1.50 to 1.55 μm for eye safe laser imaging within a more complex spectral scene. “Each” as used in this document refers to each member of a set or each member of a subset of a set. A spectral band may represent, for example, infrared light, a color of the visible spectrum, ultraviolet light, or any other range of light.

System 10 generates an image according to the image information included in the light. System 10 includes a processor 20, an electro-optical element 22, a sensor 24, an image processing module 26, and display modules 30 coupled as shown in FIG. 1. Processor 20 controls the operation of system 10. For example, processor 20 sends an electrical control signal 21 to electro-optical element 22 to control the operation of electro-optical element 22. Processor may comprise any suitable device operable to accept input, process the input according to predefined rules, and produce output, for example, any combination of hardware, software, or other logic such as a neural network.

Electro-optical element 22 filters light for specific spectral bands. Electro-optical element 22 may comprise an electrically configurable optical element that changes at least one of its optical properties in response to control signal 21. Control signal 21 may change the diffractive properties of electro-optical element 22 to change an optical property. An optical property may include any feature that affects how electro-optical element 22 interacts with light. An example of an optical property includes the effective refractive index of electro-optical element 22, which may be used to adjust the wavelength of light that electro-optical element 22 disperses. In addition, processing signal 21 may control electro-optical elements 22 to adjust the transmission amplitude or phase angle of a specific band of light.

Electro-optical element 22 may comprise a switchable grating such as a Bragg grating that separates the spectral bands of the light. The grating may comprise, for example, liquid crystal on silicon. Other types of gratings may include free-space gratings, micro-electrical-mechanical-systems gratings, or other device suitable for separating the spectral bands of light. As another example, electro-optical element 22 may comprise layers, such as a laminate of filters, where each layer is sensitive to a specific spectral band. Control signal 21 may be used to switch on and off specific layers to filter for specific spectral bands. Examples of electro-optical elements are described in more detail with reference to FIGS. 2A through 2C.

Electro-optical element 22 may have a specific configuration for a specific spectral band. For example, electro-optical element 22 may have one configuration for λ₀, another configuration for λ₁, and so on. The configuration may, for example, specify the amount of light to bend or the optical power for a specific spectral band.

Sensor 24 senses the light filtered by electro-optical element 22 to generate a signal such as a digital or analog signal that includes the image information of the light. Sensor 24 may detect certain types of energy of the light, for example, infrared energy. Sensor 24 may comprise, for example, a charge-coupled device (CCD), a lead salt sensor, or other suitable sensing device embodied in any suitable manner such as a pixel or pixel array.

Sensor 24 may have a specific configuration for a specific spectral band. For example, sensor 24 may have a particular bias or output destination with respect to a spectral band and the state of control signal 21 being feed to electro-optical element 22. The configuration of sensor 24 may be synchronized in accordance with the arrival of spectral bands from electro-optical element 22. Electro-optical element 22 may filter for spectral bands such that the spectral bands arrive at sensor 24 at different times. For example, the spectral bands may arrive at sensor 24 according to a sequence λ₁,λ₂, . . . ,λₙ. An example of the temporal shifting of bands is described with reference to FIG. 3. Sensor 24 may adjust its configuration with respect to the sequence. For example, sensor 24 is configured to sense red light as red light is received from electro-optical element 22.

Image processing module 26 combines the different spectral bands to form a composite signal 32 by, for example, multiplexing the spectral bands. Spectral bands λᵢ may be multiplexed according to a function f(λ₀,λ₁, . . . ,λₙ) of the spectral bands λᵢ. For example, spectral bands λ₁ and λ₂ may be multiplexed according to a function f(λ₁,λ₂)=λ₁/λ₂, f(λ₁,λ₂)=λ₁+A₂, or other suitable function. The function f(λ₁,λ₂) may combine spectral bands according to weights assigned to the spectral bands. For example, the spectral bands may be combined according to function f(λ₁,λ₂)=W₁λ₁/W₂λ₂, where W₁ represents a weight assigned to spectral band λ₁, and W₂ represents a weight assigned to spectral band λ₂. Any other method for combining the spectral bands, however, may be used.

Display modules 30 display an image generated from composite signal 32 received from image processing module 26. Display modules 30 may include any suitable device or combination of devices. According to the illustrated embodiment, display modules 30 include a light source 40, an electro-optical element 42, and a display 44. Light source 40 provides light for the display of the image.

Electro-optical element 42 may be used to filter the image for different optical features such as polarization or color. Electro-optical element 42 may comprise a switchable grating or a laminate of filters as described with reference to electro-optical element 22. Display 44 may be used to view the resulting image. Display 44 may comprise, for example, an organic light-emitting diode (OLED), a liquid crystal display (LCD), or other suitable device for displaying the resulting image. Display 44 may be embodied as any suitable apparatus of any suitable size. For example, display 44 may be embodied as an eye piece, a television monitor, or other suitable device.

Display 44 may be synchronized with electro-optical element 42 such that display 44 is configured to display a spectral band when the spectral band is received from electro-optical element 42. For example, display 44 may be configured to display red light as red light is received from electro-optical element 42.

Modifications, additions, or omissions may be made to system 10 without departing from the scope of the invention. For example, light source 40 and electro-optical element 42 may be omitted such that display modules 30 include only display 44. Moreover, the operations of system 10 may be performed by more or fewer components. For example, the operations of sensor 24 and image processing module 26 may be performed by one module, or the operation of image processing module 26 may be performed by multiple modules. Additionally, functions may be performed using any suitable logic comprising software, hardware, other logic, or any suitable combination of the preceding.

FIGS. 2A through 2C illustrate examples of electro-optical element 22. FIG. 2A illustrates an example of electro-optical element 22a that has layers 50. Each layer 50 may be sensitive to a particular spectral band, and control signal 21 may activate one or more layers 50 of electro-optical element 22a to filter for specific spectral bands. FIG. 2B illustrates an example electro-optical element 22b that has sections 56 forming a grid. Each section 56 may be sensitive to a particular spectral band, and control signal 21 may activate one or more sections 56 to filter for specific spectral bands. FIG. 2C illustrates an example electro-optical element 22c that has sections 58 that form concentric circles. Each section 58 may be sensitive to a specific spectral band, and control signal 21 may activate one or more sections 58 to filter for specific spectral bands.

FIG. 3 is a diagram 70 illustrating a temporal shift applied to the spectral bands by electro-optical element 22. Diagram 70 illustrates n spectral bands A₀,λ₁, . . . ,λₙ temporally shifted for system 10 in which display modules 30 are refreshed at time Ω. Electro-optical element 22 switches spectral bands at intervals of 1/n Ω resulting in a sequence λ₀,λ₁, . . . ,λₙ of n spectral bands. Sensor 24 and image processing module 26 receive the spectral bands in sequence. Image processing module 26 combines the spectral bands to yield composite signal 32.

FIG. 4 is a flowchart illustrating one embodiment of a method for multiplexing spectral bands to generate an image. The method begins at step 100, where system 10 receives light comprising image information. Electro-optical element 22 selects a spectral band at step 102. The band may be selected in response to control signal 21 received from processor 20.

Sensor 24 senses the spectral band at step 104 to generate a digital signal that describes the image information of the light. If there is a next spectral band at step 106, the method returns to step 102, where electro-optical element 22 selects the next spectral band. If there is no next spectral band at step 106, the method proceeds to step 108.

Image processing module 26 multiplexes the spectral band to generate composite signal 32 at step 108. The spectral bands may be multiplexed in accordance with a function of the spectral bands. Display modules 30 generate an image from composite signal 32 at step 110. The image may be displayed to a viewer. After generating the image, the method terminates.

Modifications, additions, or omissions may be made to the method without departing from the scope of the invention. Additionally, steps may be performed in any suitable order without departing from the scope of the invention.

Certain embodiments of the invention may provide one or more technical advantages. A technical advantage of one embodiment may be that spectral bands are multiplexed together in order to generate an image. By multiplexing spectral bands together, an image having a broad spectral range may be effectively and efficiently generated.

Although an embodiment of the invention and its advantages are described in detail, a person skilled in the art could make various alterations, additions, and omissions without departing from the spirit and scope of the present invention as defined by the appended claims.

1. A method for generating an image, comprising:
receiving light associated with a plurality of spectral bands;
repeating the following for each spectral band associated with the light:
receiving an electrical signal at an electro-optical element;
changing an optical property of the electro-optical element in response to the electrical signal to filter for a spectral band; and
transmitting the spectral band to a sensor;
sensing the spectral bands at the sensor;
combining the spectral bands to generate a composite signal; and
generating an image from the composite signal.

2. The method of claim 1, wherein the electro-optical element comprises:
a first layer sensitive to a first spectral band of the spectral bands; and
a second layer sensitive to a second spectral band of the spectral bands, the electrical signal operable to activate the first layer and to activate the second layer.

3. The method of claim 1, wherein the electro-optical element comprises:
a first section sensitive to a first spectral band of the spectral bands; and
a second section sensitive to a second spectral band of the spectral bands, the electrical signal operable to activate the first section and to activate the second section.

4. The method of claim 1, wherein combining the spectral bands to generate the composite signal comprises:
accessing a function of the spectral bands; and
multiplexing the spectral bands in accordance with the function to combine the spectral bands.

5. The method of claim 1, wherein the sensor is synchronized with the electro-optical element, the sensor being operable to sense a spectral band when the spectral band arrives at the sensor from the electro-optical element.

6. The method of claim 1, wherein generating the image from the composite signal comprises:
receiving the composite signal, the composite signal associated with a plurality of display spectral bands;
repeating the following for each display spectral band associated with the composite signal:
sending a display electrical signal to a display electro-optical element;
changing an optical property of the display electro-optical element in response to the display electrical signal to filter for a display spectral band; and
transmitting the display spectral band to a display; and
displaying the display spectral bands at the display to generate the image.

7. A system for generating an image, comprising:
a electro-optical element operable to:
receive light associated with a plurality of spectral bands;
repeat the following for each spectral band associated with the light:
receive an electrical signal;
change an optical property of the electro-optical element in response to the electrical signal to filter for a spectral band; and
transmit the spectral band to a sensor;
a sensor coupled to the electro-optical element and operable to sense the spectral bands;
an image processing module coupled to the sensor and operable to combine the spectral bands to generate a composite signal; and
a display module coupled to the image processing module and operable to generate an image from the composite signal.

8. The system of claim 7, wherein the electro-optical element comprises:
a first layer sensitive to a first spectral band of the spectral bands; and
a second layer sensitive to a second spectral band of the spectral bands, the electrical signal operable to activate the first layer and to activate the second layer.

9. The system of claim 7, wherein the electro-optical element comprises:
a first section sensitive to a first spectral band of the spectral bands; and
a second section sensitive to a second spectral band of the spectral bands, the electrical signal operable to activate the first section and to activate the second section.

10. The system of claim 7, wherein the image processing module combines the spectral bands to generate the composite signal by:
accessing a function of the spectral bands; and
multiplexing the spectral bands in accordance with the function to combine the spectral bands.

11. The system of claim 7, wherein the sensor is synchronized with the electro-optical element, the sensor being operable to sense a spectral band when the spectral band arrives at the sensor from the electro-optical element.

12. The system of claim 7, wherein the display module is operable to generate the image from the composite signal by:
receiving the composite signal, the composite signal associated with a plurality of display spectral bands;
repeating the following for each display spectral band associated with the composite signal:
sending a display electrical signal to a display electro-optical element;
changing an optical property of the display electro-optical element in response to the display electrical signal to filter for a display spectral band; and
transmitting the display spectral band to a display; and
displaying the display spectral bands at the display to generate the image.

13. A logic for generating an image, the logic embodied in a medium and operable to:
receive light associated with a plurality of spectral bands;
repeat the following for each spectral band associated with the light:
receive an electrical signal at an electro-optical element;
change an optical property of the electro-optical element in response to the electrical signal to filter for a spectral band; and
transmit the spectral band to a sensor;
sense the spectral bands at the sensor;
combine the spectral bands to generate a composite signal; and
generate an image from the composite signal.

14. The logic of claim 13, wherein the electro-optical element comprises:
a first layer sensitive to a first spectral band of the spectral bands; and
a second layer sensitive to a second spectral band of the spectral bands, the electrical signal operable to activate the first layer and to activate the second layer.

15. The logic of claim 13, wherein the electro-optical element comprises:
a first section sensitive to a first spectral band of the spectral bands; and
a second section sensitive to a second spectral band of the spectral bands, the electrical signal operable to activate the first section and to activate the second section.

16. The logic of claim 13, operable to combine the spectral bands to generate the composite signal by:
accessing a function of the spectral bands; and
multiplexing the spectral bands in accordance with the function to combine the spectral bands.

17. The logic of claim 13, wherein the sensor is synchronized with the electro-optical element, the sensor being operable to sense a spectral band when the spectral band arrives at the sensor from the electro-optical element.

18. The logic of claim 13, operable to generate the image from the composite signal by:
receiving the composite signal, the composite signal associated with a plurality of display spectral bands;
repeating the following for each display spectral band associated with the composite signal:
sending a display electrical signal to a display electro-optical element;
changing an optical property of the display electro-optical element in response to the display electrical signal to filter for a display spectral band; and
transmitting the display spectral band to a display; and
displaying the display spectral bands at the display to generate the image.

19. A system for generating an image, comprising:
means for receiving light associated with a plurality of spectral bands;
means for repeating the following for each spectral band associated with the light:
receiving an electrical signal at an electro-optical element;
changing an optical property of the electro-optical element in response to the electrical signal to filter for a spectral band; and
transmitting the spectral band to a sensor;
means for sensing the spectral bands at the sensor;
means for combining the spectral bands to generate a composite signal; and
means for generating an image from the composite signal.

20. A method for generating an image, comprising:
receiving light associated with a plurality of spectral bands;
repeating the following for each spectral band associated with the light:
receiving an electrical signal at an electro-optical element, the electro-optical element comprising a first layer sensitive to a first spectral band of the spectral bands, and comprising a second layer sensitive to a second spectral band of the spectral bands, the electrical signal operable to activate the first layer and to activate the second layer, the electro-optical element further comprising a first section sensitive to a first spectral band of the spectral bands, and comprising a second section sensitive to a second spectral band of the spectral bands, the electrical signal operable to activate the first section and to activate the second section;
changing an optical property of the electro-optical element in response to the electrical signal to filter for a spectral band; and
transmitting the spectral band to a sensor;
sensing the spectral bands at the sensor, the sensor synchronized with the electro-optical element, the sensor being operable to sense a spectral band when the spectral band arrives at the sensor from the electro-optical element;
combining the spectral bands to generate a composite signal by accessing a function of the spectral bands, and by multiplexing the spectral bands in accordance with the function to combine the spectral bands; and
generating an image from the composite signal by:
receiving the composite signal, the composite signal associated with a plurality of display spectral bands;
repeating the following for each display spectral band associated with the composite signal: sending a display electrical signal to a display electro- optical element, changing an optical property of the display electro-optical element in response to the display electrical signal to filter for a display spectral band, and transmitting the display spectral band to a display; and
displaying the display spectral bands at the display to generate the image.
